(19) United States
(12) Patent Application Publication
(10) Pub. No.: US 2004/0072366 A1
(43) Pub. Date: Apr. 15, 2004

(54) Method and device for manipulating small quantities of liquid

(76) Inventors: Achim Wixforth, Munich (DE); Christoph Gauer, Munich (DE); Jurgen Scriba, Munich (DE)

Correspondence Address: Rocco S Barrese, Dilworth & Barrese, 333 Earle Ovington Boulevard, Uniondale, NY, 11553, US

(21) Appl. No.: 10/450,795

(22) PCT Filed: Dec. 12, 2001
(86) PCT No.: PCT/EP01/14598

(30) Foreign Application Priority Data
Dec. 14, 2000 (DE) 10062246.1

(51) Int. Cl. B01L 3/00

(52) U.S. Cl. 436/180; 422/100

(57) ABSTRACT

The invention relates to a device for manipulating small quantities of liquid on a solid body surface with at least one defined holding area with wetting properties other than the surroundings, whose material is such that the liquid to be manipulated preferably stays in the holding area, whereby the holding area has at least one constriction zone which cannot be overcome by the liquid due to its surface tension in the normal state, and whereby at least one device for generating an external force is provided substantially in the direction of the at least one constriction zone. The invention also relates to a corresponding method for manipulating small quantities of liquid on solid body surfaces and a method for generating a defined quantity of liquid using the method according to the present invention.

This invention relates to a device and method for manipulating small quantities of liquid on a solid body surface and a method for producing at least one defined quantity of liquid on a solid body surface.

In microanalytics and synthesis of small quantities of liquid there is a requirement to define small quantities of liquid and to determine their volume as precisely as possible. In the present text the term liquid comprises inter alia pure liquids, mixtures, dispersions and suspensions, as well as liquids containing particles, e.g. biological material.

In “lab-on-a-chip” technology, recently come to the fore, it is preferred to move a defined quantity of liquid at a defined analysis or synthesis point on the chip. At this point e.g. chemical or physical analysis or synthesis is to be performed, wherein it is generally preferable if the volumes or quantities of the corresponding liquids are exactly known.

Such methods are used inter alia for inorganic reagents or organic material, such as cells, molecules, macromolecules or genetic materials, as described e.g. by O. Müller, Laborwelt 1/2000, pages 36 to 38. The transport of small quantities of liquid in analysis and synthesis is undertaken in known methods in microstructured channels (Anne Y. Fu et al, Nature Biotechnology 17, page 1109 ff. (1999)). There the movement of small quantities of liquid in microchannels of a few micrometres in depth or width using electroosmotic methods is described. Another already known technique is the transport of small quantities of liquid using micromechanical or electrostatic pumps in microstructured channels, as described in “Microsystem Technology in Chemistry and Life Sciences”, published by A. Manz and H. Becker (Springer Verlag, 1999), on pages 29 to 34. Electrokinetic methods have been described by M. Köhler et al. (Physikalische Blätter 56, Nr. 11, S. 57-61).

The object of the present invention is to provide an improved device and an improved method enabling effective manipulation of small quantities of liquid.

This task is solved by a device having the features of claim 1 or by a method having the characteristics of either claim 26 or 27.

The device according to the present invention has at least one defined holding area on a solid body surface, on which the at least one liquid to be manipulated is preferably kept. For this purpose the at least one defined holding area has wetting properties other than the solid body surface surrounding it. The defined holding area for the liquid can e.g. be in the form of “strip conductors” on the solid body surface, which can e.g. be realised by corresponding coating either of the defined holding area or its surroundings. At the same time it is particularly advantageous that despite the limited holding area of the liquid, which is achieved by modulation of the wetting properties, no trenches, corners or edges are necessary, on which the liquid might be affected in its movement.

The wetting properties can be modulated e.g. by definition of hydrophilic or hydrophobic areas. With manipulation of aqueous solutions the preferred holding area is e.g. selected so that it is more hydrophilic than the surrounding solid body surface. This can be achieved either by hydrophilic coating of the preferred holding area or by hydrophobic surroundings. A hydrophobic environment can e.g. be realised in a preferred design of the invention by a silanated surface.

Depending on use the solid body surface surrounding the holding area can also be hydrophilic, lipophobic or lipophilic as compared to the surface of the holding area. For manipulating non-aqueous solutions it can be advantageous if the preferred holding area is lipophilic compared to the surroundings.

The definition of the preferred holding area can also occur or be supported by etching the surface, whereby the etching depth is minimal relative to the width of the “strip conductor”, e.g. hundredth of the width. In the case of an aqueous solution the preferred holding area can be defined by the surface surrounding the preferred holding area being coated hydrophobically and being etched a few nanometres to a few micrometers into the surface in the vicinity of the holding area itself. In this way the contrast is increased with respect to the wetting angle. Yet macroscopically the surface is substantially planar. Such flat etching can be manufactured very easily and defined in manufacturing engineering terms, without the occurrence of known problems of deep etching of a narrow channel.

The wetting properties can also be modulated by microstructuring, as is the case with the so-called lotus effect, based on the varying, roughness of the surface. This can be obtained e.g. by microstructuring of the corresponding surface areas, e.g. by chemical treatment or ion radiation.

The at least one preferred holding area thus defined for the at least one quantity of liquid to be manipulated on the solid body surface has, according to the present invention, at least one constriction zone, whose width is less than the width of the adjacent parts of the preferred holding area. The width is such that the quantity of liquid cannot overcome the constriction zone due to its surface tension without an external force being exerted.

The quantity of liquid for manipulating is on the preferred holding area of the solid body surface e.g. in the form of a droplet. For a moistened area on the surface of a solid body the surface of the liquid droplet exhibits the balanced same curvature everywhere, since a different curvature in different parts of the liquid droplet surface at any given surface tension would cause a different internal pressure. Locally differing internal pressure in a droplet results, however, in a flow of liquid out of high-pressure areas into low-pressure areas. This occurs until there is pressure compensation, that is, the same curvature of surface is everywhere. For the boundary line between liquid and solid material, thus between the liquid droplet, and the solid body surface, instead of the curvature the wetting angle appears, which in balance and in an isotropic environment depends on both materials of the solid body surface or the liquid.

In the case of laterally spatially limited wetting, which is given by the definition of the preferred holding areas, the curvature of the liquid surface is determined by the width of the preferred holding area, thus the “strip conductor”, and the volume of the quantity of liquid in this holding area. If the width of the “strip conductor” is altered abruptly, then the requirement for a constant curvature over the transition between both width does not have to be satisfied, since the height of the droplet, thus the “filling height”, would also be sharply altered here. Narrow “strip conductors” can therefore not be filled out easily by wide “strip conductors”, provided there is no external force being exerted.

The width of the “strip conductors” defined by the preferred holding areas for the transport of volumes of liquid in the region of picolitres is of the order of a few micrometers. For quantities of liquid of the order of nanolitres widths of 10 to several 100 micrometers are possible.

If an external force now acts on a small quantity of liquid with a component in the direction of the constriction zone, then the latter is taken out of balance and can overcome the constriction zone. In the process the strength of the force is such that the small quantity of liquid can certainly overcome the constriction zone, but does not move outside the preferred holding area, all the same. A local change in temperature or, in a particularly preferred embodiment, the impulse transmission by a surface wave can serve to disturb the balance.

The width of the constriction zone essentially determines the strength of the external force required to overcome the constriction zone. The narrower the constriction zone, the greater the effect of the force has to be for a quantity of liquid to pass through the constriction zone. It has proven advantageous if the width of the constriction zones is less than half the width of the adjacent “strip conductors”. It is generally ensured that the surface tension prevents the constriction zone being overcome also without the effect of an external force.

With the device according to the present invention or the method according to the present invention it is thus possible to propel a small quantity of liquid at a defined point in time, namely that point in time when an external force is acting on the quantity of liquid, across a barrier otherwise insuperable for the quantity of liquid. In this way precise localising of the quantity of liquid is possible, as the preferred holding area for the quantity of liquid behind the corresponding constriction zone is filled with liquid only at a well defined point in time.

The preferred holding area, which is defined on the solid body surface, can be composed, in any form, of constriction zones and areas of greater width, thus “strip conductors” for the liquid. A network or checker board of defined faces and delimiting constriction zones can be formed here, for example. With such a network small defined quantities of liquid can be propelled under the action of an external force from a partial area of defined surface via the interposed constriction zone into a second partial area of defined surface. In this way, a network of partial areas of defined surfaces can be filled selectively via interposed constriction zones. Small quantities of liquid can thus be positioned effectively inside a network.

The partial areas of the network between the constriction zones may be in various shapes. A round shape is particularly advantageous, however. In this way the surface wetting properties at the edge of the face of the preferred holding area are defined very precisely and the quantity of liquid touches the edge of the partial area with defined face along its entire periphery with corresponding “filling ratio”.

The individual partial areas of defined surface can also have e.g. a functionalised surface, so that specific reactions can take place. Other partial areas of defined surface can be used to perform chemical or physical analysis, e.g. by applying a local electrical or magnetic field, heating or e.g. a local mechanical force. Likewise fluorescence analysis of a quantity of liquid on a specific partial area of defined surface can be performed by local detection. In other areas synthesis of different materials, which were brought in or as quantities of liquid onto a holding area of defined surface, can be carried out.

Areas having varying wetting properties or with differently functionalised surfaces can be manufactured simply and cost-effectively using already known lithographic processes and coating technologies.

The surface tension depends on thermodynamic parameters such as e.g. pressure and/or temperature. In this respect the volume of liquid, which can be stored e.g. on a geometrically defined “standard volume”, is also determined by the thermodynamic parameters. The thermodynamic parameters thus offer an option of varying the volume of liquid on at least a part of the preferred holding area in addition to the geometric dimensions in a specific area.

To generate the force, which drives the quantity of liquid through the constriction zone, various methods may be employed. A particularly simple method is to increase the temperature, e.g. with a heating unit on the solid body surface. This heating unit can either have a local effect on a holding area of defined surface or heat the entire solid body surface. In a simple design resistance heating is provided on the solid body surface. This generally causes the volume of liquid to expand and its surface tension drops. The result is thus a force which is capable of propelling the liquid across the constriction zone.

In another embodiment a micromechanical or a piezoelectrically driven pump is employed. Finally, an electrode can be used on the solid body surface to move liquids with charged particles by electrostatic forces.

In a particularly preferred embodiment the device according to the present invention has at least one surface wave generation device. This surface wave generation device generates surface waves which transfer an impulse to the quantities of liquid to be manipulated in the preferred holding area. The impulse transmission is achieved either by mechanical deformation of the solid body surface or by the dynamic effect of the accompanying electrical fields on charged or polarisable material.

Particular advantages of the impulse transmission by means of surface waves for manipulating small quantities of material are:

1) The strength of the dynamic effect on the small quantity of liquid can be adjusted over a broad area via the amplitude of the surface wave.

2) Various time lapses of the force, such as e.g. pulses of different length, can be defined electronically.

3) The effect of acoustic irradiation of the solid body surface with the surface wave is automatic cleaning of the areas washed over.

4) Control via corresponding software is highly possible.

Surface waves can be generated on piezoelectric substrates or substrates with piezoelectric areas, e.g. piezoelectric coatings. It is adequate if the substrate or the corresponding coating is present only in the area where the surface wave generation device is located. The surface sound wave spreads out outside the piezoelectric area.

An interdigital transducer known per se is advantageously utilised to generate the surface wave. Such an interdigital transducer has two electrodes which engage in one another like fingers. By applying a high-frequency alternating field, e.g. of the order of several 100 MHz, a surface wave is stimulated, whose wave length results as quotient from the surface acoustic velocity and frequency, in a piezoelectric substrate or in a piezoelectric area of the substrate. The direction of dispersion is perpendicular to the engaging finger electrode structures. A well defined surface wave can be generated very easily by means of this type of interdigital transducer. Manufacturing the interdigital transducer is cost-effective and straightforward using known lithographic processes and coating technologies. Interdigital transducers can also be controlled wireless, e.g. by irradiating an alternating electromagnetic field into an antenna device connected to the interdigital transducer.

Several particular embodiments of surface waves for manipulating the smallest quantities of liquid and generated by means of interdigital transducers are explained hereinbelow by way of example on a “network”, as already described hereinabove. A part of the preferred holding area with a defined surface is connected to other parts of the preferred holding area only via constriction zones. This partial area of defined surface is thus to be filled with liquid only via the constriction zones.

A surface wave generation device, whose surface wave expansion device is along the constriction zone, is provided for each constriction zone for this purpose. In this way at least part of a small quantity of liquid can be propelled from one part of the preferred holding area via the constriction zone into a second part of the preferred holding area with a defined surface via impulse transmission. This surface defines a “standard volume” of a small quantity of liquid, which can be effectively filled or emptied. This happens at a defined point in time when the surface wave generation device is active.

Using this type of individual surface wave generation device a drop of liquid can be propelled in this arrangement defined by a sequence of constriction zones and so the network can effectively be coated with small quantities of liquid. At the same time it is useful that a drop of liquid, which is acoustically irradiated according to the present invention with a surface wave, attenuates this. A more remote drop of liquid, affected by the surface wave thus attenuated, experiences its effect less or not at all.

Using the same or a second surface wave generation device, whose direction of dispersion is e.g. parallel to the direction of dispersion of the first surface wave generation device, a second surface wave, optionally with less intensity, can be sent in the direction of a volume of liquid in a part of the preferred holding area. Quantity and volume of the liquid can be ascertained through measuring of the attenuation of this second surface wave.

One arrangement of the network is particularly easy and secure to operate, wherein the constriction zones are vertical to one another and the directions of beam of at least two surface wave generation devices for filling or emptying the holding areas of defined surface are parallel to the constriction zones. This arrangement is particularly secure, because there are essentially no impulse components which are common to the surface waves generated by the first or second surface wave generation device.

Only one surface wave generation device can be provided for acoustic irradiation of the constriction zones, which are arranged parallel. To this end the surface wave generation device is designed as a so-called “tapered” interdigital transducer. With such a tapered interdigital transducer the finger distance along the axis of the transducer is not constant. The finger distance determines the wave length of the surface wave. When surface wave acoustic velocity is constant and when a specific frequency is thus applied only for a certain finger distance the condition of resonance is fulfilled that the frequency of the surface wave results as quotient from the surface wave acoustic velocity and the wave length. In this way a surface wave is generated which has only minimal lateral expansion vertical to the direction of dispersion. Individual constriction zones can be selected from a number of parallel arranged constriction zones.

In addition to this the device and method can also be used to create a defined volume of liquid. The method according to the present invention can further be used to supply the quantities of liquid to be manipulated e.g. to an area on the solid body substrate, where analysis or synthesis is performed. Such analysis or synthesis can e.g. be of a chemical, physical and/or biological nature. A quantity of liquid can likewise be introduced to an area, where it reacts with another quantity of liquid. In this respect the inventive device and method are suited both to analysis and to synthesis of the quantity of liquid or quantities of liquid.

The devices for generating an external force can be attached to electronic controls programmable via corresponding software.

Preferred embodiments of the invention will now be explained with reference to the attached figures. Surface wave generation devices are illustrated as examples of devices for generating an external force hereinbelow, wherein:

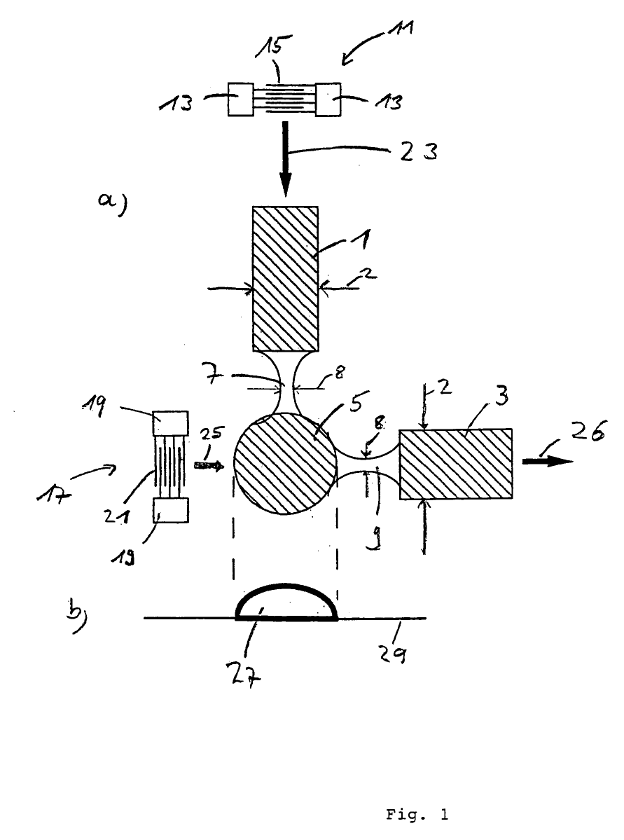

FIG. 1a is a diagrammatic plan view of an inventive embodiment for defining the smallest quantities of liquid,

FIG. 1b is a diagrammatic side elevation of the embodiment of FIG. 1a, and

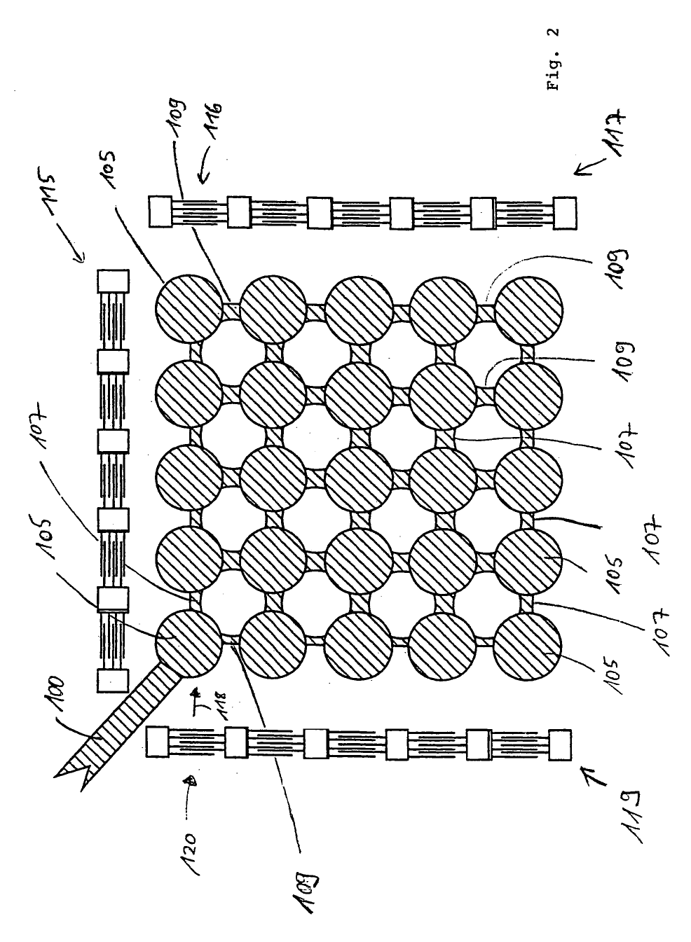

FIG. 2 is a diagrammatic plan view of a second embodiment.

In FIG. 1 partial areas 1 and 3 of a preferred holding area with a width, designated by 2, are provided for the liquid to be manipulated. The exact form of areas 1 and 3 and their width may be different. Connecting to areas 1 and 3 are constriction zones 7 and 9, which are created in the same way as areas 1 and 3, as described further hereinbelow. The constriction zones connect to a round area 5. The width 8 of the constriction zones 7 and 9 is less than half the width 2 of the areas 1 and 3 and must not necessarily be equal for different constriction zones. The whole arrangement is situated on the surface of a solid body, e.g. a chip. This can comprise e.g. piezoelectric material, e.g. quartz or LiNbO₃, or have an at least partial piezoelectric surface, e.g. made of ZnO.

The preferred holding areas 1, 3, 5, 7 and 9 have wetting properties other than the surrounding surface of the solid body, such that the liquid to be manipulated stays preferably in areas 1, 3, 5, 7 and 9. In an aqueous solution the surface in the preferred holding areas is e.g. hydrophilic, as compared to the more hydrophobic surface of the remaining solid body. This can be achieved e.g. by the solid body surface in the surrounding areas being silanated or microstructured and thus becomes hydrophobic.

The width 2 is e.g. a few micrometers and is suited to manipulation of quantities of liquid in the picolitre to the nanolitre range. Reference numerals 11 or 17 designate surface wave generation devices with beam direction 23 or 25. The illustrated embodiment concerns an interdigital transducer with electrodes 13 or 19, with finger-like interengaging projections 15 or 21. When an alternating filed is applied to the electrodes of the individual transducer a surface wave with a wave length corresponding to the finger distance of the electrodes is generated. The direction of dispersion is perpendicular to the interengaging fingers. The transducers comprise a large number of fingers, with only a few being illustrated diagrammatically here, and not to scale.

Various wave types, such as e.g. Rayleigh waves or shear waves can be generated by choice of crystal orientation.

Interdigital transducers have been created e.g. using lithographic methods and coating processes on the chip surface and are contacted via the electrodes 13 or 19.

Reference numeral 26 designates the direction in which the quantity of liquid can be propelled with the help of the interdigital transducer 17. The surface of the area 5 is round and has a defined size.

FIG. 1b shows a diagrammatic sectional view through the area of the solid body surface, where the preferred holding area 5 is located. A drop of liquid 27 is indicated on the solid body surface 29.

The device according to the present invention of FIG. 1 is utilised as follows. The “strip conductor” 1 is filled externally with the liquid to be manipulated, forming a “liquid column”. This wets the strip conductor 1 up to just in front of constriction 7. The curvature of the liquid surface is determined by the width of the “strip conductor” 1 and the volume of the quantity of liquid. By altering the width in transitioning from the “strip conductor” 1 to the width 8 of the constriction zone 7 the requirement for a constant curvature across the carry-over between both widths cannot be fulfilled because the height of the liquid droplet would also change considerably. The narrow constriction zone 7 cannot easily be filled without additional effect from the wide strip conductor 1. By means of a surface wave, which is irradiated in the direction 23 of the transducer 11, the quantity of liquid can be “pumped” through the constriction zone 7 all the same. The required strength of the surface wave can be determined by preliminary calibration or adjusted during the experiment until the quantity of liquid moves away via the constriction zone 7 to the surface 5. In this way a defined quantity of liquid travels from the strip conductor 1 to the defined surface 5.

If the required quantity of liquid is available on the surface 5, then it can be analysed, e.g. by physical or chemical processes, or is available for reacting with another substance.

Whichever quantity is in each holding area 5 can be measured by measuring the attenuation of a surface wave which is sent over the area of the solid body surface, containing the surface 5. Interdigital transducers (not illustrated in the figure) can be provided for this which are opposite one another and have the surface 5 between them. If a surface wave of optionally less intensity is sent by one of these interdigital transducers in the direction of the surface 5, then the surface wave is attenuated by the presence of the liquid. The more liquid is available, the greater the attenuation is as a rule. The second opposite (also not illustrated) interdigital transducer aids in detecting the surface wave, so that the attenuation can be determined.

On the other hand after the desired quantity of liquid is obtained by means of the second illustrated interdigital transducer 17 a surface wave in the direction of 25 can be sent on the quantity of liquid to the defined surface 5. Via impulse transmission of this surface wave the quantity of liquid is propelled via the constriction zone 9 similarly as described hereinabove for the constriction zone 7. It reaches the strip conductor 3 through its movement in the direction of 26. In this way a defined volume of liquid can be created. Just when the desired quantity of liquid is at the area 5, precisely this quantity of liquid is propelled from area 5 by means of the second surface wave, generated using the interdigital transducer 17.

The embodiment of FIG. 1 accordingly allows precise definition of the smallest quantities of liquid with simultaneous planar surface of the solid body. With local heating, e.g. with resistance heating, not show in the figures, or by means of infrared heating the surface tension of the liquid can be decreased, necessitating a lower strength of the surface wave for overcoming the constriction zone. In this way the “standard volume” of the defined surface 5 can also be adjusted within certain limits.

Not shown in each case is a possible coupling of the preferred holding areas e.g. by means of a constriction zone of a “strip conductor” to a microfluid system, in which various functions of a “lab-on-a-chip” can be executed or various reactions can take place. The illustrated parts of the preferred holding area can be filled by this constriction zone. The constriction zone must also be sufficiently narrow for it not to be overcome by the liquid without the effect of an external force, due to its surface tension. Due to an external impulse effect, e.g. via a surface wave also, the drop of liquid can overcome this constriction zone and reach the illustrated parts of the preferred holding area.

A reservoir, which is formed by a larger surface having the same wetting properties as the illustrated holding areas, can be situated on the other side of such a constriction zone. A larger quantity of liquid can be stored thereon. Due to external impulse effect e.g. of a surface wave a quantity of liquid can be propelled out of this reservoir via the described constriction zone in the illustrated parts of the holding area. Alternatively, the illustrated holding areas can also be filled e.g. with a pipette.

With an embodiment according to FIG. 2 drops of liquid can be transported directly to specific sites on the surface and deposited there. A checkerboard arrangement is shown as a special embodiment. A number of defined partial areas corresponding to the area 5 of FIG. 1a is shown, of which just a few are illustrated by way of example with 105. These are interconnected via constriction zones 107 or 109. A “strip conductor” 100 with a greater width than the width of the constriction zones acts as supply. The areas 100, 105, 107, 109 again have wetting properties other than the surrounding solid body surface, similarly to the embodiment of FIG. 1.

In the illustrated embodiment groups 115, 117 and 119 are provided with interdigital transducers which can be controlled separately. The individual transducers are equipped such that the direction of dispersion is in each case along a series of constriction zones 107 or 109. By way of example this is shown on the interdigital transducer 120 by the direction of dispersion 118. In the illustrated embodiment of FIG. 2 the groups of interdigital transducers 119 and 117 are opposite one another. Naturally another group of interdigital transducers can be provided also on the other side of the checker-board pattern opposite the group of interdigital transducers 115.

A certain quantity of liquid is introduced via the “strip conductor” 100 to the defined holding area in FIG. 2 at top left. Corresponding strip conductors can of course lead to other defined areas 105 also. Due to the described effect of surface tension the quantity of liquid is prevented from entering other surface areas 105 by way of the adjacent constriction zones. As a result of generating a surface wave by an alternating field being applied e.g. to the interdigital transducer 120 the quantity of liquid is “pumped” away via the adjacent constriction zone to the nearest surface area 105, as described. In the process the direction 118 sets the direction for the surface wave. In this way the drop of liquid can be transported from one area 105 to the next by corresponding switching of the interdigital transducer, until it has reached the chosen site. The individual constriction zones are each emptied due to the prevalent higher internal pressure at the expense of the surfaces 105.

The liquid originates e.g. from a reservoir, comprising a surface with wetting properties, such as “strip conductors”, so that the liquid preferably stays there. This area may have a larger surface for storing a corresponding quantity of liquid. It is connected e.g. via the strip conductor 100 and/or a corresponding constriction zone to the system which can in turn be overcome by the liquid only by acoustic irradiation with a surface wave.

In this way a partial area of defined surface 105 can be filled after the other in the direction of the surface wave 118. If e.g. the last holding area of defined surface of a series is filled, then the process starts over from the beginning. Attenuation of the surface wave by the drop of liquid in front of it prevents drops remote from the surface wave generation device from being strongly influenced. The drop of liquid in FIG. 2 can be moved in a vertical direction using the interdigital transducer of group 115 in a similar fashion.

By means of the opposite transducer, shown by way of example via the transducer 116 with respect to the transducer 120, the drops of liquid can be retracted again.

In addition, using transmission measurements of the surface wave from one interdigital transducer to an opposite interdigital transducer, for example transducers 120 and 116, at a lesser amplitude a measurement can also be made as to whether the individual surfaces 105 are filled with liquid or not, as the surface wave is attenuated by the presence of the liquid. The lesser amplitude is selected so that the droplets leave their respective holding area 105 not via the adjacent constriction zone.

Constriction zones e.g. leading to a large surface which is similarly functionalised, such as the areas 105, 107, 109 can of course be connected, as in FIG. 2, to the lower series of surfaces 105. By irradiating a strong surface wave using the transducer of group 115 the network can then be completely emptied into this large surface.

A “microtiter plate” for subsequent fluorescence analysis can be realised using the inventive embodiment of FIG. 2. At the same time drops of liquid on various surfaces 105 are subjected to e.g. fluorescence analysis. Similarly, it can be arranged that individual surfaces 105 are functionalised with a surface coating leading to a reaction. This reaction takes place locally only on this individual area and can be examined precisely.

In a non-illustrated embodiment, instead of the groups of interdigital transducers 115, 117, 119, in each case a tapered interdigital transducer can be provided whose finger distance is not constant along its axis. With such tapered interdigital transducers the site of radiation can be adjusted with the frequency, since the frequency results as a quotient from the constant surface wave velocity and the wave length which corresponds to the finger distance. By setting a corresponding frequency the choice can thus be made as to which group of constriction zones situated in one line is to be addressed.

It is understood that the individual embodiments of the invention can be combined to form a whole system. Likewise the individual elements can optionally form part of a larger overall system on a single chip which has even more measuring and analysis or synthesis stations in the form of a “lab-on-the-chip”, apart from the inventive embodiments. The inventive devices and methods can be used particularly advantageously for moving and positioning small quantities of liquid on such integrated systems. The overall structure can be manufactured very easily using known lithographic processes and integrated on a chip with other elements which are provided e.g. for transport or analysis of small quantities of materials.

1. A device for manipulating small quantities of liquid on a solid body surface with
a solid body substrate with a surface (29)
at least one holding area (1, 3, 5, 7, 9, 100, 105, 107, 109) on the solid body surface (29), which has wetting properties other than the surrounding solid body surface and whose material is such that the liquid to be manipulated (27) preferably stays on the holding area, whereby at least one of the holding areas comprises at least one constriction zone (7, 9, 107, 109) of minimal width (8) which is less than the width (2) of the adjacent parts of the holding area, and which cannot be overcome by the liquid (27) due to its surface tension without the additional effect of an external force, without at least partly leaving the holding area (1, 3, 5, 7, 9, 100, 105, 107, 109), and
at least one device (11, 17, 116, 120) for generating an external force with a component in the direction of the at least one constriction zone.

2. The device as claimed in claim 1, with a device for controlling the device (11, 17, 116, 120) for generating an external force which can be programmed by software.

3. The device as claimed in claim 1, wherein the modulation of the wetting properties is realised by at least one hydrophobic and at least one comparatively hydrophilic or at least one lipophobic and at least one comparatively lipophilic area.

4. The device as claimed in claim 3, wherein the at least one hydrophilic and the at least one hydrophobic or the at least one lipophilic and the at least one lipophobic area are defined lithographically.

5. The device as claimed in any one of claims 1 to 4, wherein the areas of varying wetting properties are defined by lateral micro- or nanostructured areas.

6. The device as claimed in any one of claims 1 to 5, wherein the areas of varying wetting properties are defined by corresponding functionalising and/or coating.

7. The device as claimed in any one of claims 1 to 6, wherein the width (2) in a spatial direction of the at least one holding area (1, 3, 5, 100, 105) outside a constriction zone (7, 9, 107, 109) is a few millimetres maximum and the width (8) of a constriction zone (7, 9, 107, 109) is less than half the width (2) of the at least one holding area outside the constriction zone.

8. The device as claimed in any one of claims 1 to 7, wherein the width (2) in a spatial direction of the at least one holding area (1, 3, 5, 100, 105) outside a constriction zone (7, 9, 107, 109) is a few nanometres minimum and the width (8) of a constriction zone (7, 9, 107, 109) is less than half the width (2) of the at least one holding area outside the constriction zone.

9. The device as claimed in any one of claims 1 to 8, wherein at least one partial area (5, 105) of the at least one holding area is connected via at least only one constriction zone (7, 9, 107, 109) to other parts (1, 3) of the holding area (1, 3) and has a defined surface.

10. The device as claimed in claim 9, with at least two constriction zones (7, 9, 107, 109) which are connected to the defined partial area (5, 105) of the holding area, whose alignment is not parallel.

11. The device as claimed in claim 10, wherein at least two of the constriction zones (7, 9, 107, 109) are each assigned at least one device (11, 17, 116, 120) for generating an external force substantially in the direction of each assigned constriction zone (7, 9).

12. The device as claimed in any one of claims 10 or 11, wherein the alignment of the non-parallel constriction zones (7, 9, 107, 109) is vertical to each other.

13. The device as claimed in any one of claims 9 to 12, wherein the partial area (5, 105) of defined surface of the holding area is essentially round.

14. The device as claimed in any one of claims 1 to 13 with at least one holding area with a plurality of partial area (105) which are connected to one another via a plurality of constriction zones (107, 109) in the manner of a network.

15. The device as claimed in claim 14 with at least one first device (120) for generating an external force along those constriction zones which are situated along a straight line.

16. The device as claimed in claim 15 with at least one second device (116) for generating an external force against the direction of the external force which can be generated with the first device (120) for generating an external force.

17. The device as claimed in any one of claims 1 to 16, wherein the at least one device (11, 17, 116, 120) for generating an external force comprises a surface wave generation device.

18. The device as claimed in claim 17, which comprises at least one interdigital transducer (11, 17, 116, 120) as surface wave generation device.

19. The device as claimed in claim 18, wherein at least one interdigital transducer with non-constant finger distance is provided for surface wave generation.

20. The device as claimed in any one of claims 1 to 19 which comprises a piezoelectric solid body substrate or a substrate with at least one piezoelectric area for generating surface waves.

21. The device as claimed in any one of claims 1 to 20, wherein the at least one device comprises a heating unit, preferably a resistance heating unit, for generating an external force.

22. The device as claimed in any one of claims 1 to 21, wherein the at least one device for generating an external force has at least one micromechanical pump.

23. The device as claimed in any one of claims 1 to 22, wherein the at least one device for generating an external force includes at least one piezoelectric pump.

24. The device as claimed in any one of claims 1 to 23, wherein the at least one device for generating an external force includes at least one electrode.

25. The device as claimed in any one of claims 1 to 24, with at least one device for altering the temperature.

26. A method for manipulating small quantities of liquid on a solid body surface, wherein a quantity of liquid (27) which is situated on a partial area (1, 3, 5, 105) of a holding area of the solid body surface generated by modulation of the wetting properties, is moved via impulse transmission of an external force along a constriction zone (7, 9, 107, 109) of the holding area which is connected to the partial area and which, without the impulse effect of an external force due to the surface tension of the liquid (27), would not be passed through by the latter.

27. A method for generating a defined quantity of liquid, wherein by means of a method as claimed in claim 26 a quantity of liquid is moved into a partial area (5) of a holding area (1, 3, 5, 7, 9) generated by modulation of the wetting properties which has a defined surface and is connected only via constriction zones (7, 9) to the remaining holding area (1, 3) on the solid body surface.

28. The method as claimed in claim 27, wherein the quantity of liquid in the partial area (5) of the holding area of defined surface is detected by attenuation of a surface wave which passes through the solid body surface in the vicinity of the partial area (5) of defined surface.

29. The method as claimed in any one of claims 27 or 28, wherein the partial area (5) of defined surface is emptied by impulse transmission of an external force.

30. The method as claimed in any one of claims 27 to 29, wherein with adjustment of the external thermodynamic parameters, preferably pressure and/or temperature, the volume of the quantity of liquid determined by the surface tension and the internal pressure of the quantity of liquid (27) can be varied on the partial area (5) of the holding area of defined surface.

31. The method as claimed in claim 30, wherein the temperature on the solid body surface is changed by means of a heating unit.

32. The method as claimed in any one of claims 26 to 31, wherein surface waves are used for generating the external force.
